(19) United States
(12) Patent Application Publication
(10) Pub. No.: US 2018/0319700 A1
(43) Pub. Date: Nov. 8, 2018

(54) LOW-BORON, BARIUM-FREE, ALKALINE EARTH ALUMINOSILICATE GLASS AND ITS APPLICATIONS

(71) Applicant: KORNERSTONE MATERIALS TECHNOLOGY COMPANY, LTD., Fuzhou, Fujian (CN)

(72) Inventors: Jack Y. Ding, Fuzhou, Fujian (CN); Peter Liang, Fuzhou, Fujian (CN)

(21) Appl. No.: 15/770,870

(22) PCT Filed: Dec. 1, 2015
(86) PCT No.: PCT/CN2015/096163

§ 371 Date: Apr. 25, 2018

(51) Int. Cl. C03C 3/091; C03C 3/087

(52) U.S. Cl. CPC C03C 3/091; C03B 17/064; C03C 3/087

(57) ABSTRACT

A low-boron, barium-free, alkaline earth alumino-silicate glass composition having a low content of B₂O₃, high content of Al₂O₃, and a controlled ratio of (B₂O₃+CaO+MgO+SrO)/Al₂O₃. The glass composition may be suitable for low temperature poly-Si thin film transistors on substrates having a high glass strain point temperature.

### FIELD

The present disclosure relates to low-boron, barium-free, alkaline earth alumino-silicate glass and its applications. These glasses may find application in the processing of low-temperature poly-Si thin film transistors.

### BACKGROUND

Flat-panel displays are commonplace in today's commercial electronic devices. The next generation of handheld electronics will place increasingly stringent demands on their displays. Displays able to meet these demands will enable a wide variety of commercial applications. Therefore, the properties of the glass used to manufacture flat-panel displays has become an important design consideration, especially with the booming development of Thin Film Transistor Liquid Crystal Display (TFT-LCD) technology. For example, TFT-LCD display technology requires high quality glass substrates having an alkali ion content of less than 0.1 wt % to avoid contaminating semiconductor thin film materials with alkali metal ions. Also, TFT-LCDs require a coefficient of thermal expansion of from about 29×10⁻⁷/° C. to about 40×10⁻⁷/° C. to reduce the thermal stress produced when heating a glass substrate and non-crystalline silicon materials together during semiconductor processing.

The three most common TFT (Thin Film Transistor) technologies are a-Si TFT (amorphous silicon TFTs or α-Si TFTs), low temperature Poly-Si TFT (low temperature polycrystalline silicon TFTs or “LTPS-TFTs”) and high temperature Poly-Si TFT (high temperature polycrystalline silicon TFTs or “HTPS-TFTs”). At present a-Si TFT technology is the most popular and most mature. However, research has shown that Poly-Si has excellent electron mobility, providing TFT products with quick response times, high brightness, high resolution, and low energy-consumption. With these advantages, Poly-Si will be developed for improving AM-LCD (active matrix liquid crystal display) and OLED (organic light emitting diode) displays.

During LTPS-TFT processing a Poly-Si thin film must form on a glass substrate during a heat treatment in the processing range of about 400° C. to about 625° C. Therefore, the glass used as a substrate in TFT processing must withstand temperatures of at least 625° C. while maintaining good rigidity. Strain point temperature and softening point temperature are glass properties that are often used to determine if a glass substrate is appropriate for processing at the required temperatures whereas Young's modulus is a property that relates to the stiffness of a glass substrate and can limit film thickness.

The strain point temperature of glass defines the highest temperature to which a particular glass can be heated if it is going to be cooled in atmospheric conditions without defects. The softening point temperature defines the highest temperature to which a material can be heated before reaching some predetermined softness. A glass heated above its strain point temperature or its softening point temperature will experience structural relaxation of thermal stress, resulting in glass structure densification and irreversible shrinkage.

As noted above, Young's modulus is another material property that relates to the stiffness of a solid material such as glass. The larger the Young's modulus, the less likely the material is to deform. Young's modulus is often considered when determining film composition and thickness.

Generally, shrinkage and/or deformation of a substrate leads to thin film non-uniformity and device defects such as pixel pitch deformation and deviation. Therefore, glass used as a substrate in TFT processing must have strain point and softening point temperatures greater than 625° C. However, glass compositions having a higher glass strain point temperature or larger Young's modulus are advantageous and allow greater processing ranges.

### SUMMARY

An alkaline earth alumino-silicate glass is presented herein. Physical properties of the exemplary embodiments presented herein are measured as described below in reference to Tables 3 and 4.

According to several exemplary embodiments, the alkaline earth aluminosilicate glass has a composition that includes in mole percent (mol %) on an oxide basis:
from about 64.0% to about 77.0% of SiO₂,
from about 8.0% to about 18.0% of Al₂O₃,
from about 0.0% to about 6.0% of B₂O₃,
from about 0.0% to about 7.0% of MgO,
from about 5.0% to about 14.0% of CaO,
from about 0.5% to about 9.0% of SrO,
from about 0.0% to about 0.5% of SnO₂, and
from about 75.0% to about 87.0% of SiO₂+Al₂O₃,
wherein 2.5>(B₂O₃+CaO+MgO+SrO)/(Al₂O₃), and wherein 0.7>(MgO)/(CaO+SrO).

According to several exemplary embodiments, the alkaline earth aluminosilicate glass has a composition that includes in mol % on an oxide basis:
from about 66.0% to about 75.0% of SiO₂,
from about 8.5% to about 16.0% of Al₂O₃,
from about 1.5% to about 5.0% of B₂O₃,
from about 0.5% to about 6.0% of MgO,
from about 6.0% to about 12.0% of CaO,
from about 1.8% to about 8.0% of SrO, and
from about 0.0% to about 0.5% of SnO₂.

According to several exemplary embodiments, the alkaline earth aluminosilicate glass has a composition that includes in mol % on an oxide basis:
from about 68.0% to about 73.0% of SiO₂,
from about 10.0% to about 14.0% of Al₂O₃,
from about 1.5% to about 3.5% of B₂O₃,
from about 1.0% to about 4.0% of MgO,
from about 8.0% to about 12.0% of CaO,
from about 1.8% to about 5.0% of SrO, and
from about 0.0% to about 0.5% of SnO₂.

According to several exemplary embodiments, the alkaline earth aluminosilicate glass has a composition that includes in mol % on an oxide basis:
from about 66.0% to about 75.0% of SiO₂,
from about 8.0% to about 16.0% of Al₂O₃,
from about 1.5% to about 5.0% of B₂O₃,
from about 1.0% to about 4.0% of MgO,
from about 8.0% to about 14.0% of CaO,
from about 1.8% to about 9.0% of SrO, and
from about 0.0% to about 0.5% of SnO₂.

According to several exemplary embodiments, the alkaline earth aluminosilicate glass for low temperature poly-Si TFT has a composition that includes in mol % on an oxide basis:
from about 64.0% to about 77.0% of SiO₂,
from about 10.0% to about 18.0% of Al₂O₃,
from about 0.0% to about 5.0% of B₂O₃,
from about 0.0% to about 7.0% of MgO,
from about 5.0% to about 14.0% of CaO,
from about 0.5% to about 9.0% of SrO,
from about 0.0% to about 0.5% of SnO₂, and
from about 75.0% to about 87.0% of SiO₂+Al₂O₃, wherein 2.1>(B₂O₃+CaO+MgO+SrO)/(Al₂O₃), and wherein 0.7>(MgO)/(CaO+SrO).

According to several exemplary embodiments, the alkaline earth aluminosilicate glass has a composition includes in mol % on an oxide basis:
from about 66.0% to about 75.0% of SiO₂,
from about 8.5% to about 16.0% of Al₂O₃,
from about 1.5% to about 5.0% of B₂O₃,
from about 0.5% to about 4.0% of MgO,
from about 8.0% to about 12.0% of CaO,
from about 1.8% to about 8.0% of SrO,
from about 0.0% to about 0.5% of SnO₂, and
from about 78.0% to about 84.0% of SiO₂+Al₂O₃,
wherein 2.1>(B₂O₃+CaO+MgO+SrO)/(Al₂O₃)>1.2, and
wherein 0.55>(MgO)/(CaO+SrO),
   wherein the glass composition was prepared by the overflow down draw method.

According to several exemplary embodiments, the alkaline earth aluminosilicate glass has the following properties:
(a) a strain point temperature that is greater than or equal to 690° C.;
(b) a softening point temperature that is greater than 980° C.;
(c) a coefficient of thermal expansion (CTE) from about 29×10⁻⁷/° C. to about 40×10⁻⁷/° C. at a temperature from about 50° C. to about 300° C.;
(d) a viscosity of 316 poise at a temperature from about 100° C. to about 1650° C.; and
(e) a liquidus temperature from about 100° C. to about 1250° C.

According to several exemplary embodiments, the alkaline earth aluminosilicate glass has the following properties:
(a) a strain point temperature that is greater than or equal to 710° C.;
(b) a softening point temperature that is greater than or equal to 1000° C.;
(c) a coefficient of thermal expansion (CTE) from about 31×10⁻⁷/° C. to about 38×10⁻⁷/° C. at a temperature from about 50° C. to about 300° C.;
(d) a viscosity of 316 poise at a temperature from about 100° C. to about 1640° C.; and
(e) the liquidus temperature from about 100° C. to about 1220° C.

According to several exemplary embodiments, the alkaline earth aluminosilicate glass has the following characteristics:
(a) the content of BaO is from about 0 ppm to about 2000 ppm;
(b) the density of the glass is less than 2.65 g/cm³; and
(c) the Young's modulus of the glass is greater than or equal to 75 GPa.

According to several exemplary embodiments, the alkaline earth aluminosilicate glass has at least one of the following characteristics:
(a) the glass is barium-free;
(b) the density of the glass is less than 2.62 g/cm³; and
(c) the Young's modulus of the glass is greater than or equal to 78 GPa.

### DETAILED DESCRIPTION

The term “about” indicates a range which includes ±5% when used to describe a single number. When applied to a range, the term “about” indicates that the range includes −5% of a numerical lower boundary and +5% of an upper numerical boundary, unless the lower boundary is 0. For example, a range of from about 100° C. to about 200° C., includes a range from 95° C. to 210° C. However, when the term “about” modifies a percentage, then the term means±1% of the number or numerical boundaries, unless the lower boundary is 0%. Thus, a range of 5-10%, includes 4-11%. A range of 0-5%, includes 0-6%.

According to several exemplary embodiments, the alkaline earth aluminosilicate glass is referred to as having a composition that is “barium-free” or “without BaO,” which refers to a concentration of BaO that is less than 2000 ppm.

According to several exemplary embodiments, the alkaline earth aluminosilicate glass is an “alkali-free glass,” which refers to a glass having a composition that includes alkali metal oxides in a concentration of less than 1000 ppm.

The term “alkaline earth aluminosilicate glass” refers to an aluminosilicate glass containing at least one oxide of the alkaline earth metals, which include Ba, Mg, Ca, Sr, Ra, and Be.

The phrase “in mol percent on an oxide basis” or “in mol % on an oxide basis” refers to the percentage of moles of the oxide to the total number of moles in the glass. It is understood that the total number of mol percent in the glass always adds up to and never exceeds 100%.

According to several exemplary embodiments, the alkaline earth aluminosilicate glass has a composition that includes SiO₂ and Al₂O₃ as glass formers that exist almost exclusively as [SiO₄] and [AlO₄]. The concentration of SiO₂+Al₂O₃ in the glass composition is greater than 75.0 mol % to provide a strain point temperature higher than 690° C. and a coefficient of thermal expansion lower than 40×10⁻⁷/° C. across the temperature range of from about 50° C. to about 300° C. On the other hand, the concentration of SiO₂+Al₂O₃ in the glass composition is less than 87.0 mol % to avoid producing permanent flaws like bubbles and stripes. According to several exemplary embodiments, the concentration of SiO₂+Al₂O₃ in the glass composition is from about 78.0 mol % to about 84.0 mol %.

According to several exemplary embodiments, the alkaline earth aluminosilicate glass has a composition that includes from about 64.0 mol % to about 77.0 mol % of SiO₂. If the concentration of SiO₂ in the glass composition is less than 64.0 mol %, it can be difficult to attain a high strain point, low density, good mechanical strength, and good chemical resistance. However, if the concentration of SiO₂ in the glass composition is greater than 77.0 mol %, then the melting temperature of the glass is increased, which can cause easy devitrification. According to several exemplary embodiments, the alkaline earth aluminosilicate glass has a composition that includes a concentration of SiO₂ of from about 66.0 mol % to about 75.0 mol % or from about 68.0 mol % to about 73.0 mol %.

According to several exemplary embodiments, the alkaline earth aluminosilicate glass has a composition that includes from about 8.0 mol % to about 18.0 mol % of Al₂O₃. Al₂O₃ greatly increases the viscosity of the glass and if the concentration of Al₂O₃ in the glass composition is less than 8.0 mol %, it is difficult to achieve a glass with a strain point temperature greater than 690° C. However, if the concentration of Al₂O₃ is greater than 18.0 mol % this may cause the glass to suffer from easy devitrification and lower mechanical strength. Further, at concentrations of Al₂O₃ that are greater than 18.0 mol %, the viscosity of the glass is increased, such that the molten glass becomes very difficult to process. According to several exemplary embodiments, the alkaline earth aluminosilicate glass has a composition that includes a concentration of Al₂O₃ of from about 8.0 mol % to about 16.0 mol %, from about 8.5 mol % to about 16.0 mol %, from about 10.0 mol % to about 14.0 mol %, or from about 10.0 mol % to about 18.0 mol %.

According to several exemplary embodiments, B₂O₃ serves as a glass former and exists almost exclusively as [BO₃] and [BO₄], which can increase the glass structure formability and reduce the coefficient of thermal expansion of the glass. Also, [BO₄] serves as a glass network former and forms glass network structures together with [SiO₄]. At the same time, B₂O₃ can reduce the glass viscosity and melting temperature, accelerating glass clarification. However, too much B₂O₃ can lower the strain point temperature of the glass. Therefore, according to several exemplary embodiments, the alkaline earth aluminosilicate glass has a composition that includes from about 0 to about 6.0 mol % of B₂O₃. If the concentration of B₂O₃ in the glass composition exceeds about 6.0 mol %, then the strain point temperature of the glass is greater 690° C. Also, if the concentration of B₂O₃ in the glass composition exceeds about 6.0 mol %, it will reduce the chemical durability of the glass. According to several exemplary embodiments, the alkaline earth aluminosilicate glass has a composition that includes a concentration of B₂O₃ of from about 0 mol % to about 5.0 mol %, from about 1.5 mol % to about 5.0 mol % or from about 1.5 mol % to about 3.5 mol %.

According to several exemplary embodiments, the alkaline earth aluminosilicate glass has a composition that includes CaO, MgO and SrO. These oxides can be beneficial for glass clarification, but can also destroy the glass structure and reduce the glass melting temperature. Further, these oxides can increase the coefficient of thermal expansion of the glass and reduce the strain point temperature of the glass, leading to deterioration of the chemical durability of the glass. Therefore, the amounts of these oxides, if present, are limited so as to reduce the coefficient of thermal expansion of the glass and to increase the strain point temperature of the glass.

According to several exemplary embodiments, high concentrations of CaO in the composition of the alkaline earth aluminosilicate glass can reduce the liquidus temperature of the glass. Nevertheless, CaO is a commonly used component of glass compositions because it is inexpensive and readily commercially available compared to other metal oxides. According to several exemplary embodiments, the alkaline earth aluminosilicate glass has a composition that includes from about 5.0 mol % to about 14.0 mol % of CaO. If the concentration of CaO in the glass composition exceeds 14.0 mol %, then the coefficient of thermal expansion will be too high leading to glass devitrification. If the concentration of CaO in the glass composition is less than 5.0 mol %, then it is difficult to increase the chemical stability and mechanical strength of the glass. According to several exemplary embodiments, the alkaline earth aluminosilicate glass has a composition that includes a concentration of CaO of from about 6.0 mol % to about 12.0 mol %, from about 8.0 mol % to about 14.0 mol %, or from about 8.0 mol % to about 12.0 mol %.

According to several exemplary embodiments, the alkaline earth aluminosilicate glass has a composition that includes from about 0 mol % to about 7.0 mol % of MgO. If the concentration of MgO in the glass composition is greater than 7.0 mol %, the glass density properties will be reduced, and glass devitrification properties will be lost. Further, MgO concentrations of more than 7.0 mol % will lower the chemical durability of the glass and increase the liquidus temperature of the glass, which is detrimental for overflow down draw processing. According to several exemplary embodiments, the alkaline earth aluminosilicate glass has a composition that includes a concentration of MgO of from about 0.5 mol % to about 6.0 mol %, from about 0.5 mol % to about 4.0 mol % or from about 1.0 mol % to about 4.0 mol %.

According to several exemplary embodiments, the alkaline earth aluminosilicate glass has a composition that includes SrO which can lower the glass melting temperature, glass devitrification, and the liquidus temperature of the glass. However, when the alkaline earth aluminosilicate glass has a composition that includes too much SrO, this can lead to an undesirable reduction in the glass density. Taking glass density and strain point temperature requirements into consideration, the SrO concentration in the glass composition is from about 0.5 mol % to about 9.0 mol %. If the SrO concentration is above 9.0 mol %, then the glass density and coefficient of thermal expansion will be too high. According to several exemplary embodiments, the alkaline earth aluminosilicate glass composition includes a concentration of SrO of from about 1.8 mol % to about 9.0 mol %, from about 1.8 mol % to about 8.0 mol % or from about 1.8 mol % to about 5.0 mol %.

According to several exemplary embodiments, the alkaline earth aluminosilicate glass has a composition that includes a concentration ratio of B₂O₃+CaO+MgO+SrO to Al₂O₃ that is less than about 2.5 to achieve a high strain point temperature. According to several exemplary embodiments, the alkaline earth aluminosilicate glass has a composition that includes a concentration ratio of B₂O₃+CaO+MgO+SrO to Al₂O₃ of from about 1.2 to about 2.1.

According to several exemplary embodiments, the alkaline earth aluminosilicate glass has a composition that includes a concentration ratio of MgO to (CaO+SrO) that is less than about 0.7, which lowers the liquidus temperature of the glass composition to less than 1250° C. According to several exemplary embodiments, the alkaline earth aluminosilicate glass composition has a composition that includes a concentration ratio of MgO to (CaO+SrO) that is less than about 0.55.

According to several exemplary embodiments, the alkaline earth aluminosilicate glass composition has a composition that includes a concentration of SnO₂ of from 0 to about 0.5 mol %, which serves as the refiner.

According to several exemplary embodiments, a method is provided for manufacturing an alkaline earth aluminosilicate glass. According to several exemplary embodiments, the method includes:
mixing and melting the components to form a homogenous glass melt;
shaping the glass using the down-draw method, the floating method, or combinations thereof; and
annealing the glass.

According to several exemplary embodiments, the manufacture of the alkaline earth aluminosilicate glass may be carried out using conventional down-draw methods which are well known to those of ordinary skill in the art and which customarily include a directly or indirectly heated precious metal system consisting of a homogenization device, a device to lower the bubble content by means of fining (refiner), a device for cooling and thermal homogenization, a distribution device and other devices. The floating method includes floating molten glass on a bed of molten metal, typically tin, resulting in glass that is very flat and has a uniform thickness.

According to several exemplary embodiments of the method for manufacturing an alkaline earth aluminosilicate glass described above, the glass composition is melted for up to about 12 hours at about 1650° C. According to several exemplary embodiments of the method for manufacturing an alkaline earth aluminosilicate glass described above, the glass composition is melted for up to about 6 hours at about 1650° C. According to several exemplary embodiments of the method for manufacturing an alkaline earth aluminosilicate glass described above, the glass composition is melted for up to about 4 hours at about 1650° C.

According to several exemplary embodiments of the method for manufacturing an alkaline earth aluminosilicate glass described above, the glass composition is annealed at a temperature of 780° C. for about 2 hours, and then cooled at a rate of about 1.0° C./hour until the glass reaches 690° C., after which the glass composition is allowed to cool to room temperature (or about 21° C.).

According to several exemplary embodiments of the alkaline earth aluminosilicate glass described above, the glass may be used as a substrate for a-Si TFTs, LTPS-TFTs, and HTPS-TFTs. According to several exemplary embodiments of the alkaline earth aluminosilicate glass described above, the glass may be used to produce televisions, computers, sensors, mobile electronic devices, and other electronic devices that require non-crystalline silicon.

The following examples are illustrative of the compositions and methods discussed above.

### EXAMPLES

Preparation of a Test Sample

An alkaline earth aluminosilicate glass composition that included the components shown below in Table 1 was prepared as follows:

TABLE 1

| Oxides | Mole % |
|---|---|
| SiO₂ | 70.50 |
| Al₂O₃ | 11.50 |
| B₂O₃ | 3.20 |
| CaO | 9.90 |
| MgO | 1.00 |
| SrO | 3.80 |
| SnO₂ | 0.10 |

Batch materials, as shown in Table 2 were weighed and mixed before being added to a 2 liter plastic container. The batch materials used were of chemical reagent grade quality.

TABLE 2

| Batch Raw Materials | Batch Weight (gm) |
|---|---|
| Sand | 352.04 |
| Alumina hydroxide | 148.88 |
| Boric acid | 38.51 |
| Calcarea carbonica | 82.52 |
| Magnesia | 3.35 |
| Strontium carbonate | 32.66 |
| Tin oxide | 1.26 |

The particle size of the sand was between 0.045 and 0.25 mm. A tumbler was used for mixing the raw materials to make a homogenous batch as well as to break up soft agglomerates. The mixed batch was transferred from the plastic container to an 800 ml platinum-rhodium alloy crucible for glass melting. The platinum-rhodium crucible was placed in an alumina backer and loaded in a high temperature furnace equipped with MoSi heating elements operating at a temperature of 1000° C. The temperature of the furnace was gradually increased to 1650° C. and the platinum-rhodium crucible with its backer was held at this temperature for approximately 3-8 hours. The glass sample was then formed by pouring the molten batch materials from the platinum-rhodium crucible onto a stainless steel plate to form a glass patty. While the glass patty was still hot, it was transferred to an annealer and held at a temperature of 780° C. for 2 hours and was then cooled at a rate of 1° C./min. to 690° C. After that, the sample was cooled naturally to room temperature (21° C.).

The results for the composition shown in Table 1 above are shown in Table 3 and designated as “Ex. 1”. Additional compositions show in Tables 3 and 4 and designated as “Ex. 2” to “Ex. 18” were prepared in a similar manner as described above for the composition designated as Ex. 1.

TABLE 3

| | Sample No. | | | | | | | | | |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 |
| SiO₂ | 71.50 | 70.00 | 68.50 | 68.00 | 70.50 | 70.00 | 73.00 | 74.00 | 66.10 | 64.60 |
| Al₂O₃ | 10.00 | 10.00 | 12.80 | 12.50 | 11.50 | 11.50 | 10.50 | 10.90 | 13.80 | 11.20 |
| B₂O₃ | 3.00 | 4.80 | 2.80 | 2.50 | 3.20 | 3.40 | 2.95 | 1.50 | 3.00 | 6.00 |
| CaO | 10.50 | 12.00 | 11.50 | 9.00 | 9.90 | 13.10 | 10.50 | 10.00 | 13.00 | 7.80 |
| MgO | 2.00 | 1.20 | 0.30 | 5.00 | 1.00 | 0.00 | 0.10 | 0.50 | 1.00 | 1.80 |
| SrO | 2.90 | 1.90 | 4.00 | 2.90 | 3.80 | 2.85 | 2.85 | 2.90 | 3.00 | 8.50 |
| SnO₂ | 0.10 | 0.10 | 0.10 | 0.10 | 0.10 | 0.10 | 0.10 | 0.20 | 0.10 | 0.10 |
| SiO₂ + Al₂O₃ | 81.50 | 80.00 | 81.30 | 80.50 | 82.00 | 81.50 | 83.50 | 84.90 | 79.90 | 75.80 |
| (B₂O₃ + MgO + | 1.84 | 1.99 | 1.45 | 1.55 | 1.56 | 1.68 | 1.56 | 1.37 | 1.45 | 2.24 |
| CaO + SrO)/ | | | | | | | | | | |
| Al₂O₃ | | | | | | | | | | |
| MgO/ | 0.15 | 0.09 | 0.02 | 0.42 | 0.07 | 0 | 0.01 | 0.04 | 0.06 | 0.17 |
| (CaO + | | | | | | | | | | |
| SrO) | | | | | | | | | | |
| d (g/cm³) | 2.53 | 2.51 | 2.58 | 2.59 | 2.55 | 2.53 | 2.51 | 2.53 | 2.60 | 2.64 |
| a₍₅₀₋₃₀₀₎ (×10⁻⁷/ | 36.2 | 37.4 | 35.1 | 34.1 | 34.8 | 36.5 | 35.6 | 35.4 | 35.3 | 39.2 |
| ° C.) | | | | | | | | | | |
| T_{melting} (° C.) | 1598 | 1577 | 1642 | 1622 | 1637 | 1631 | 1620 | 1627 | 1636 | 1565 |
| T_{working} (° C.) | 1326 | 1312 | 1356 | 1347 | 1358 | 1351 | 1345 | 1348 | 1359 | 1305 |
| T_{liquidus} (° C.) | 1170 | 1120 | 1160 | 1155 | 1140 | 1180 | 1190 | 1185 | 1190 | 1080 |
| T_{softening} (° C.) | 1004 | 992 | 1033 | 1021 | 1025 | 1023 | 1018 | 1022 | 1024 | 984 |
| Tₐₙₙₑₐₗ (° C.) | 764 | 753 | 789 | 778 | 782 | 781 | 774 | 780 | 785 | 748 |
| Tₛₜᵣₐᵢₙ (° C.) | 708 | 696 | 730 | 715 | 720 | 723 | 713 | 721 | 726 | 691 |
| E (MPa) | 81.5 | 82.6 | 83.0 | 84.0 | 82.4 | 84.8 | 82.5 | 83.0 | 86.1 | 75.0 |
| G (MPa) | 33.3 | 33.6 | 34.4 | 34.5 | 33.8 | 34.5 | 33.8 | 34.1 | 35.2 | 31.0 |
| μ | 0.22 | 0.23 | 0.20 | 0.22 | 0.22 | 0.23 | 0.22 | 0.21 | 0.22 | 0.21 |

TABLE 4

| | Sample No. | | | | | | | |
|---|---|---|---|---|---|---|---|---|
| | Ex. 11 | Ex. 12 | Ex. 13 | Ex. 14 | Ex. 15 | Ex. 16 | Ex. 17 | Ex. 18 |
| SiO₂ | 65.20 | 74.00 | 69.20 | 70.50 | 76.60 | 71.00 | 69.40 | 64.90 |
| Al₂O₃ | 12.80 | 8.50 | 11.10 | 10.40 | 10.50 | 11.90 | 13.80 | 16.50 |
| B₂O₃ | 4.30 | 4.40 | 4.20 | 3.00 | 1.50 | 2.50 | 1.50 | 0.80 |
| CaO | 5.6 | 8.20 | 10.50 | 10.00 | 7.60 | 10.10 | 11.00 | 13.80 |
| MgO | 7.00 | 1.00 | 2.00 | 0.00 | 0.20 | 1.50 | 3.80 | 1.70 |
| SrO | 4.90 | 3.80 | 2.90 | 6.00 | 3.50 | 2.90 | 0.50 | 1.90 |
| SnO₂ | 0.20 | 0.10 | 0.10 | 0.10 | 0.10 | 0.10 | 0.1 | 0.4 |
| SiO₂ + Al₂O₃ | 78.00 | 82.50 | 80.30 | 80.90 | 86.10 | 82.90 | 83.20 | 81.40 |
| (B₂O₃ + MgO + | 1.70 | 2.05 | 1.77 | 1.83 | 1.21 | 1.43 | 1.22 | 1.10 |
| CaO + SrO)/ | | | | | | | | |
| Al₂O₃ | | | | | | | | |
| MgO/ | 0.67 | 0.08 | 0.15 | 0 | 0.02 | 0.12 | 0.33 | 0.11 |
| (CaO + SrO) | | | | | | | | |
| d (g/cm³) | 2.62 | 2.58 | 2.54 | 2.57 | 2.51 | 2.55 | 2.57 | 2.55 |
| a₍₅₀₋₃₀₀₎ (×10⁻⁷/ | 31.5 | 35.0 | 35.1 | 35.6 | 33.3 | 34.8 | 35.0 | 35.3 |
| ° C.) | | | | | | | | |
| T_{melting} (° C.) | 1576 | 1601 | 1613 | 1606 | 1648 | 1642 | 1645 | 1631 |
| T_{working} (° C.) | 1314 | 1326 | 1342 | 1334 | 1364 | 1359 | 1365 | 1352 |
| T_{liquidus} (° C.) | 1210 | 1135 | 1120 | 1080 | 1140 | 1145 | 1120 | 1180 |
| T_{softening} (° C.) | 991 | 1008 | 1013 | 1009 | 1036 | 1032 | 1036 | 1027 |
| Tₐₙₙₑₐₗ (° C.) | 756 | 765 | 772 | 768 | 786 | 785 | 793 | 781 |
| Tₛₜᵣₐᵢₙ (° C.) | 698 | 708 | 712 | 709 | 726 | 721 | 734 | 721 |
| E (MPa) | 81.5 | 78.6 | 82.7 | 78.7 | 82.0 | 83.8 | 85.9 | 87.7 |
| G (MPa) | 33.7 | 32.2 | 33.8 | 32.5 | 33.9 | 34.1 | 35.3 | 36.4 |
| μ | 0.21 | 0.22 | 0.22 | 0.21 | 0.21 | 0.22 | 0.22 | 0.21 |

### Definition of Symbols and Measurement of Physical Properties

The physical properties of the glass samples were measured and are listed in Tables 3 and 4. The definition of each symbol used in Tables 3 and 4 is shown below:
A. d: density (g/ml) which is measured with the Archimedes method (ASTM C-693), environmental temperature is 22+/−0.5° C.;
B. a: coefficient of thermal expansion (CTE) which is the amount of linear dimensional change from 50° C. to 300° C. as measured by ASTM E-228 dilatometry;
C. Tₘ: temperature at a viscosity of 316 poise as measured by ASTM C-965 high temperature cylindrical viscometer;
D. T_{w}: glass working temperature at a viscosity of 10⁴ poise, measured by ASTM C-965 high temperature cylindrical viscometer;
E. T_{liq}: liquidus temperature where the first crystal is observed in a boat within a gradient temperature furnace (ASTM C829-81). Generally the test is 24 hours for the crystallization process.
F. T_{soft}: glass softening temperature at a viscosity of 10^{7.6} poise as measured by the ASTM C-338 fiber elongation method;
G. Tₐ: glass annealing temperature at a viscosity of 10¹³ poise as measured by the ASTM C-336 fiber elongation method;
H. Tₛ: glass strain point temperature at a viscosity of 10^{14.5} poise as measured by the ASTM C-336 fiber elongation method;
I. E: Young's Modulus (MPa), measured by the ASTM E1876 resonance method;
J. G: shear modulus (MPa), measured by the ASTM E1876 resonance method;
K. μ: Poisson's ratio, measured by the ASTM E1876 resonance method.

While the present invention has been described in terms of certain embodiments, those of ordinary skill in the art will recognize that the invention can be practiced with modification within the spirit and scope of the appended claims.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The present disclosure has been described relative to certain embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. An alkaline earth aluminosilicate glass having a composition comprising in mol % on an oxide basis:
from about 64.0% to about 77.0% of SiO₂;
from about 8.0% to about 18.0% of Al₂O₃;
from about 0.0% to about 6.0% of B₂O₃;
from about 0.0% to about 7.0% of MgO;
from about 5.0% to about 14.0% of CaO;
from about 0.5% to about 9.0% of SrO;
from about 0.0% to about 0.5% of SnO₂;
from about 75.0% to about 87.0% of SiO₂+Al₂O₃;
wherein 2.5>(B₂O₃+CaO+MgO+SrO)/(Al₂O₃); and
wherein 0.7>(MgO)/(CaO+SrO).

2. The alkaline earth aluminosilicate glass of claim 1, wherein the glass has a composition comprising in mol % on an oxide basis:
from about 66.0% to about 75.0% of SiO₂;
from about 8.5% to about 16.0% of Al₂O₃;
from about 1.5% to about 5.0% of B₂O₃;
from about 0.5% to about 6.0% of MgO;
from about 6.0% to about 12.0% of CaO;
from about 1.8% to about 8.0% of SrO; and
from about 0.0% to about 0.5% of SnO₂.

3. The alkaline earth aluminosilicate glass of claim 1, wherein the glass has a composition comprising in mol % on an oxide basis:
from about 68.0% to about 73.0% of SiO₂;
from about 10.0% to about 14.0% of Al₂O₃;
from about 1.5% to about 3.5% of B₂O₃;
from about 1.0% to about 4.0% of MgO;
from about 8.0% to about 12.0% of CaO;
from about 1.8% to about 5.0% of SrO; and
from about 0.0% to about 0.5% of SnO₂.

4. The alkaline earth aluminosilicate glass of claim 1, wherein the glass has a composition comprising in mol % on an oxide basis:
from about 66.0% to about 75.0% of SiO₂;
from about 8.0% to about 16.0% of Al₂O₃;
from about 1.5% to about 5.0% of B₂O₃;
from about 1.0% to about 4.0% of MgO;
from about 8.0% to about 14.0% of CaO;
from about 1.8% to about 9.0% of SrO; and
from about 0.0% to about 0.5% of SnO₂.

5. An alkaline earth aluminosilicate glass suitable for low temperature poly-Si TFT, wherein the glass has a composition comprising in mol % on an oxide basis:
from about 64.0% to about 77.0% of SiO₂;
from about 10.0% to about 18.0% of Al₂O₃;
from about 0.0% to about 5.0% of B₂O₃;
from about 0.0% to about 7.0% of MgO,
from about 5.0% to about 14.0% of CaO;
from about 0.5% to about 9.0% of SrO;
from about 0.0% to about 0.5% of SnO₂; and
from about 75.0% to about 87.0% of SiO₂+Al₂O₃;
wherein 2.1>(B₂O₃+CaO+MgO+SrO)/(Al₂O₃);
wherein 0.7>(MgO)/(CaO+SrO); and
wherein the glass composition comprises less than about 1000 ppm of alkali metal oxides.

6. An alkaline earth aluminosilicate glass prepared by an overflow down draw method having a composition comprising in mol % on an oxide basis:
from about 66.0% to about 75.0% of SiO₂;
from about 8.5% to about 16.0% of Al₂O₃;
from about 1.5% to about 5.0% of B₂O₃;
from about 0.5% to about 4.0% of MgO;
from about 8.0% to about 12.0% of CaO;
from about 1.8% to about 8.0% of SrO;
from about 0.0% to about 0.5% of SnO₂;
from about 78.0% to about 84.0% of SiO₂+Al₂O₃;
wherein 2.1>(B₂O₃+CaO+MgO+SrO)/(Al₂O₃)>1.2; and
wherein 0.55>(MgO)/(CaO+SrO).

7. The alkaline earth aluminosilicate glass of claims 1, 5 and 6, wherein the glass has at least one property selected from the group consisting of:
(a) a strain point temperature that is greater than or equal to 690° C.;
(b) a softening point temperature that is greater than 980° C.;
(c) a coefficient of thermal expansion (CTE) from about 29×10⁻⁷/° C. to about 40×10⁻⁷/° C. at a temperature from about 50° C. to about 300° C.;
(d) a viscosity at 316 poise from about 100° C. to about 1650° C.; and
(e) a liquidus temperature from about 100° C. to about 1250° C.

8. The alkaline earth aluminosilicate glass of claim 7, wherein the glass has at least one property selected from the group consisting of:
(a) a strain point temperature that is greater than or equal to 710° C.;
(b) a softening point temperature that is greater than or equal to 1000° C.;
(c) a coefficient of thermal expansion (CTE) from about 31×10⁻⁷/° C. to about 38×10⁻⁷/° C. at a temperature from about 50° C. to about 300° C.;
(d) a viscosity at 316 poise from about 100° C. to about 1640° C.; and
(e) a liquidus temperature from about 100° C. to about 1220° C.

9. The alkaline earth aluminosilicate glass of claims 1, 5 and 6, wherein:
(a) the glass composition comprises from about 0 ppm to about 2000 ppm of BaO;
(b) the glass has a density of less than 2.65 g/cm³; and
(c) the glass has a Young's modulus that is greater than or equal to 75 GPa.

10. The alkaline earth aluminosilicate glass of claim 9, wherein the glass has at least one characteristics selected from the group consisting of:
(a) the glass is barium-free;
(b) the glass has a density of less than 2.62 g/cm³; and
(c) the glass has a Young's modulus that is greater than or equal to 78 GPa.
